(19) United States
(12) Patent Application Publication
(10) Pub. No.: US 2007/0184276 A1
(43) Pub. Date: Aug. 9, 2007

(54) Article having a surface treatment and method of applying same

(76) Inventors: Ronald Thiemann, Cincinnati, OH (US); Mark F. Smith, Amelia, OH (US); Donald S. Copland, Brookville, IN (US); John T. Turner, West Chester, OH (US)

Correspondence Address: Mark F. Smith, 905 Ohio Park, Cincinnati, OH, 45245, US

(21) Appl. No.: 11/702,294

(22) Filed: Feb. 5, 2007

Related U.S. Application Data
(60) Provisional application No. 60/764,971, filed on Feb. 3, 2006.
(60) Provisional application No. 60/794,461, filed on Apr. 24, 2006.

(51) Int. Cl. B32B 27/00; B05D 3/00

(52) U.S. Cl. 428/411.1; 427/398.1

(57) ABSTRACT

The surface treatment of the present invention is formed from a thermoplastic powder that can be used for a large variety of applications including, but not limited to, containers, flooring, table tops, bathroom fixtures, such as tubs, shower stalls, and the like, trays, coasters, tray supports, tools, measuring devices, musical instrument parts, motorized vehicle surfaces, building structures and components, bridges, railroad and mass transportation articles, and instruments. Further, such surface treatments having illuminating materials and/or reflective materials can be used for flooring or wall surfaces or on articles for operating in darken conditions or conditions with limited visibility.

### CROSS-REFERENCE TO RELATED APPLICATION

This application is based on and claims benefit to U.S. provisional patent application Ser. No. 60/764,971, filed on Feb. 3, 2006, and on U.S. provisional patent application Ser. No. 60/794,461, filed on Apr. 24, 2006.

### BACKGROUND OF THE INVENTION

The subject invention is direct to an article having a surface treatment thereon and, more particularly, to an article having a surface effective for reducing or preventing surface from being damaged such as by oxidation, foreign substances, or minor impacts and a method of applying the surface treatment to an article.

There is a large demand for protective surfaces or surface treatments for providing either a no-slip surface and/or a protective barrier for a variety of articles. Such demand is especially high for surfaces that can provide a sufficient protection while not detrimentally detracting from the appearance of the article. While numerous surface treatments are known, it has been found that they are often difficult to apply, relatively expensive, or do not provide an attractive appearance thereby making them unacceptable for many applications. In addition, some applications often require that the resulting surface be clear or transparent after it is applied to an article. Materials, such as urethane, while acceptable for certain applications are relatively expensive and are often cost prohibitive for many purposes. Further, many surface treatments are difficult to attach to certain substrates due to adhesion difficulties and the potential for foreign material contamination.

One such treatment that has been developed is disclosed in U.S. Pat. No. 6,740,355 to Thiemann where the no-slip surface is formed from a conventional thermographic powder, such as a granular thermo plastic resin, which is deposited along a substrate. The powdered substrate us then subjected to heat sufficient to melt of soften the powder and adhere it onto the substrate. Unfortunately, certain uses requires or can benefit from other methods of application. In addition, certain uses can greatly benefit from modifications or additions to be composition forming the no-slip surface.

Accordingly, a need exists for a surface treatment for an article that can be permanently or temporarily attached to the article, that provides the required protection and/or no-slip characteristics, that can be clear or transparent, that is easily applied using various application methods, does not detrimentally detract from the appearance of the article, and which is relatively cost effective for most applications.

### SUMMARY OF THE INVENTION

The present invention is directed to an article having a surface treatment thereon which is formed from a conventional thermographic powder. In a preferred embodiment of the invention, the thermography powder is applied to a substrate having an adhesive layer for attaching the thermography powder to the substrate.

In a preferred embodiment of the invention the substrate is an adhesive transfer tape.

In another preferred embodiment of the invention the substrate includes adhesive glue applied thereto.

In another preferred embodiment of the invention the adhesive glue is water based adhesive glue.

In another preferred embodiment of the invention the adhesive glue is an acrylic based adhesive glue.

In another preferred embodiment of the present invention, the surface treatment comprises a fused thermographic powder.

In another preferred embodiment of the present invention, the surface treatment is formed by dipping a substrate having at least a portion of the surface of the substrate having an adhesive thereon into a supply of thermographic powder.

In another preferred embodiment of the present invention, the surface treatment is formed by applying a heated thermographic powder directly to the surface of a substrate.

In another preferred embodiment of the present invention, the surface treatment is formed by applying a thermographic powder in a molten state to the surface of a substrate.

In another preferred embodiment of the present invention, the surface treatment is reheated to allow the surface treatment to form a relatively smooth surface.

In another preferred embodiment of the present invention, the surface treatment is formed by heating and applying the thermographic powder to at least a portion of the surface of a substrate.

In another preferred embodiment of the present invention, the surface treatment is formed by heating and applying a mixture of thermographic powders to at least a portion of the surface of a substrate.

In another preferred embodiment of the present invention, the surface is formed by applying one or more thermographic powders, the particles forming said mixture are of different sizes.

In another preferred embodiment of the invention, the thermographic powder is a polyamide resin.

Another preferred embodiment of the invention is a method of applying a surface treatment utilizing a thermographic process.

In a preferred embodiment of the invention, the method comprises a holt-melt system.

In another preferred embodiment of the invention, the method comprises the use of a sprayer.

In another preferred embodiment of the invention, the method comprises the use of a slot (ribbon) coater.

In another preferred embodiment of the present invention, the thermographic powder forms a clear or transparent surface.

In another preferred embodiment of the invention, the thermographic powder comprises colored pigment to form a colored or a colored transparent surface.

In another preferred embodiment of the present invention, the surface treatment is formed utilizing a thermographic process.

In another preferred embodiment of the invention the surface treatment further includes a biological agent such as an antibacterial agent, a germicide agent, an antiviral agent, and a pesticide.

In another preferred embodiment of the invention, the surface treatment includes illumination means.

In another preferred embodiment of the invention, the surface treatment includes a reflecting means.

In another preferred embodiment of the invention, the surface treatment includes means for increasing or decreasing the surface treatment, such means includes, but is not limited to, silicas, epoxies, waxes, urethanes, TEFLON, and silicone.

In another preferred embodiment of the invention the surface treatment further includes means for increasing the roughness of the surface treatment.

In another preferred embodiment of the invention the surface treatment includes means for reducing the transparency of UV rays passing through the surface treatment.

In another preferred embodiment of the invention the surface treatment further includes means for providing an encapsulating delivery means.

In another preferred embodiment of the invention the surface treatment is formed from a first thermoplastic powder having a first melting point and a second thermoplastic powder having a second melting point.

In another preferred embodiment of the invention, the substrate is formed from a heat shrinkable material.

In another preferred embodiment of the invention, the surface treatment is physically treated to further increase or decrease its coefficient of friction.

Another preferred embodiment of the present invention is an article for use as flooring and the like.

In another preferred embodiment of the present invention, the article is a counter top, table top, and the like.

In another preferred embodiment of the invention, the article is a bathroom fixture, such as a tub, shower stall, and the like.

In another preferred embodiment of the invention, the article is for use on flooring.

In another preferred embodiment of the invention, the article is for use on counter tops, table tops, and the like.

In another preferred embodiment of the invention, the article is for use on windows.

In another preferred embodiment of the invention, the article is for use on eyewear.

In another preferred embodiment of the invention, the article is for use on clothing and wearing accessories to maintain them in proper position.

In another preferred embodiment of the invention, the article is for use food and beverage containers.

In another preferred embodiment of the invention, the article is a motorized vehicle.

In another preferred embodiment of the invention, the article is a railroad car.

In another preferred embodiment of the invention, the article is a building structure.

In another preferred embodiment of the invention, the article is a bridge structure.

In another preferred embodiment of the invention, the article is an article for transporting objects.

In another preferred embodiment of the invention, the article is a fixture used in a high moisture environment.

In another preferred embodiment of the invention, the article is for use in a sandy and/or dirt environment.

In another preferred embodiment of the invention, the article is for use in a salty environment.

In another preferred embodiment, the article includes a handle having a surface treatment applied thereto.

In another preferred embodiment, the invention includes various articles and devices having a surface treatment of the present invention applied thereon.

In another preferred embodiment of the invention, is an article for use in wet or moisture environments having the surface treatment of the present invention applied thereto.

Another preferred embodiment of the invention is a method of applying a surface treatment utilizing a thermographic process.

In another preferred embodiment of the present invention, the thermographic process comprises the step of selecting the composition and texture and thickness of the protective surface and heating the thermographic powder to the proper temperature and for the proper amount of time to form the desired surface.

In another preferred embodiment of the invention, the thermographic process further includes the step of selecting the desired coefficient of friction of the surface.

Another preferred embodiment of the invention the surface treatment can be easily removed.

Other preferred embodiments and advantages of the invention will be apparent from the following description and the accompanying drawings.

### BRIEF DESCRIPTION OF THE DRAWINGS

To provide a more complete understanding of the present invention and further features and advantages thereof, reference is now made to the following description taken in conjunction with the accompanying drawings, in which:

FIG. 1 is a partial perspective side view of an article having a surface for providing a substrate for receiving the surface treatment of the present invention;

FIG. 2 is a schematic showing the process steps of forming the surface treatment of FIG. 1;

FIG. 3 is a schematic diagram illustrating a method of forming the surface treatment of FIG. 1;

FIG. 4 is a top plan view of another preferred embodiment of the surface treatment of the present invention showing means for increasing or decreasing the coefficient of friction of the surface treatment;

FIG. 5 is another preferred embodiment of the invention showing another preferred embodiment of the invention showing the surface treatment applied to an article;

FIG. 6 is the surface treatment of FIG. 5 further comprising apertures for cooperating with wicking material to reduce the build up of moisture forming along the surface of the surface treatment;

FIG. 7 is another preferred embodiment of the invention showing the surface treatment applied to the nose piece of conventional glasses;

FIG. 8 is another preferred embodiment of the invention showing the surface treatment deposited on a substrate comprising a static cling material for use as a window treatment; and

FIG. 9 is another preferred embodiment of the invention showing the surface treatment deposited on a surface of an article or structure to provide a protective barrier to the treated surface.

### DETAILED DESCRIPTION OF THE INVENTION

The present invention is directed to an article having a surface treatment and a method of applying the surface treatment to the article. Although specific embodiments of the invention will now be described with reference to the drawings, it should be understood that such embodiments are by way of example only and merely illustrative of but a small number of the many possible specific embodiments which can represent applications of the principles of the invention. Various changes and modifications obvious to one skilled in the art to which the invention pertains are deemed to be within the spirit, scope and contemplation of the invention as further defined in the appended claims.

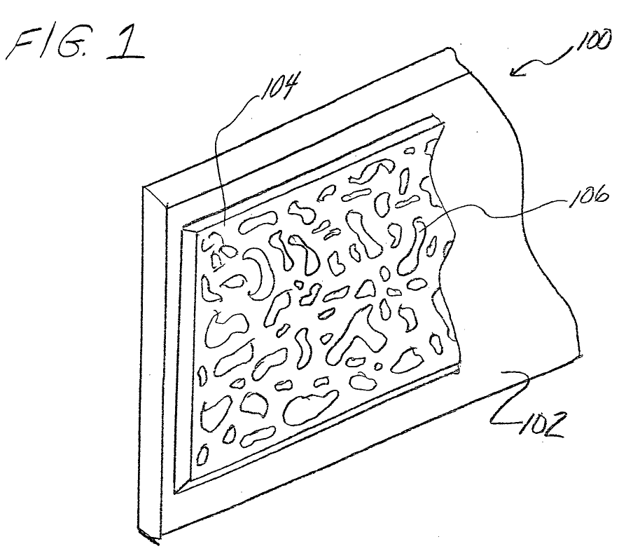

Referring to FIGS. 1, an article 100 is shown having a surface which operates as a substrate 102 for receiving a surface treatment 104. In a preferred embodiment of the invention, the surface treatment 104 is formed from a conventional thermographic powder 106, such as a granular thermoplastic resin, or a mixture of thermoplastic powder(s) and agents for enhancing the surface treatment, which is deposited along the substrate 102. One such powder is a polyamide thermographic powder. The powdered substrate 102 is then subjected to heat sufficient to melt the powder 106 and adhere it onto the substrate 102.

Thermography is an established printing process and typically involves depositing particles of thermographic powder on a thin sheet or film material that has a powder adhering material, such as an ink, glue, and the like, which can be of any color including clear, placed thereon in the form of a pattern or a printed image. The powder has the characteristic of melting under the effect of heat and of forming, after fusion, a film or a relief. Excess powder is removed, such as by suction or by air blast, to be recycled and the sheet or film material is then subjected to heat that fuses the powder and the adhering material to a the sheet or film material. After the powder is fused onto the material, it is then cooled by passing through a cooler or by use of a blast of cool air which chills and solidifies the powder. Such suitable thermography processes and apparatus for placing a powder adhering liquid in a selected pattern on a thin sheet or film material, depositing a thermographic powder thereon, and for heating and cooling the sheet or film material and powder are well known to those of ordinary skill in the art. However, such apparatus and processes have not been used for forming a surface treatment for use in protecting the surface of an article of for applying a surface treatment to the surface of an object such as disclosed herein.

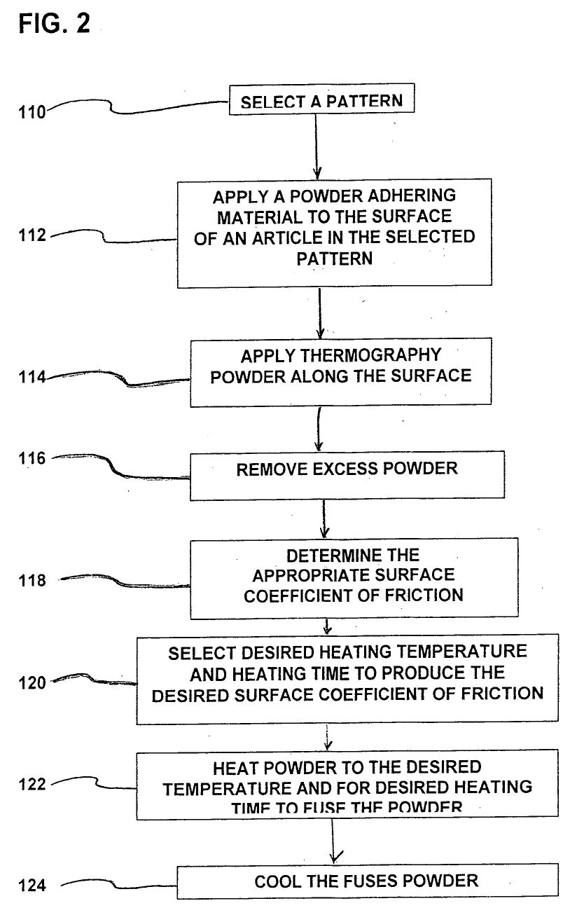

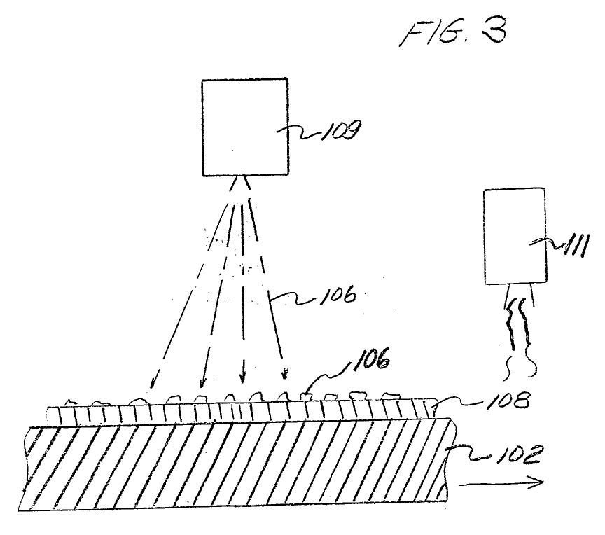

As shown in FIGS. 1, 2 and 3, the thermographic process of the present invention begins with the step of selecting the area of the surface of an article 100 to be treated (a suitable substrate 102, step 110). Preferably the substrate 102 has a suitable adhering material 108, such as glue, ink, adhesive and the like (step 112) thereon. The adhering material 108 is formulated to adhere to various substrate materials, such as plastics, like acyclic, acrylonitrile-butadiene-styrene, polycarbonates, and poly vinyl chlorides, painted surfaces, metal surfaces, and the like. The adhering material 108 is preferably applied in a preselected pattern using a conventional silk screen process. Preferably, the substrate 102 is then passed under a shaker 109 or other similar device (step 114) that deposits and agitates a quantity of thermographic powder 106 over the substrate 102 which adheres to the powder adhering material 108. The thermographic powder 106 is a powder conventionally used for thermographic printing and can be an opaque powder, such as a metallic powder or a pigmented powder, or a transparent powder or a colored transparent powder. Excess powder 106 is then removed (step 116) using a convention process such as by suction or by air blast, to be recycled.

In another preferred embodiment of the invention, the substrate and adhering material are formed together such as a one sided or two sided tape. The tape having the adhering material exposed is then run through a container containing the thermography powder such that the powder clings to the exposed adhering material. It should be understood that the speed of the tape going through the powder and the density and amount of thermography powder exposed to the tape can be easily determined for effectively coating the tape. It should be understood that substrates having adhesive glues, including water based adhesive glues, epoxy, and other such adhesives may also be used for attaching the substrate of the surface treatment to the surfaces of various articles.

In a preferred embodiment, the desired surface coefficient of friction (step 118) and the appropriate heating temperature and time (step 120) are then selected and the substrate 102 is then passed through a conventional heating apparatus 111, such as a tunnel-type oven, where it is heated (step 122) to melt or soften and fuse the thermographic powder 106 onto the substrate 102. The substrate 102 and the fused thermographic powder 106 are then cooled (step 124) to reduce the likelihood of smearing the fused powder 106.

The fusing of the thermographic powder 106 to the substrate 102 is a critical part of the surface treatment. By selecting the appropriate amount of heat and the appropriate length of heating time, the resulting roughness of the surface can be varied to produce the desired surface coefficient of friction. For example, by reducing the heat and/or the amount of heating time to melt or soften and fuse the thermographic powder, the roughness and the corresponding surface coefficient of friction can be increased. By increasing the heat and/or the length of heating time to melt and fuse the thermographic powder, the corresponding coefficient of friction of the surface treatment can be reduced. It should be understood that the specific combination of heat and time for a given application can be easily determined by one skilled in the art. It should also be understood that the thermographic powder, as used herein, may comprise a mixture of thermographic powders and/or thermographic powder resins having different melting points to provide a surface treatment having the desired coefficient of friction, texture, softness, and the like.

In another preferred embodiment of the invention a thermographic powder is applied in its molten state to at least a portion of the surface of a substrate, thereby not requiring the use of an adhesive material for some applications. The thermographic powder is then cooled and solidified to form the surface treatment on that portion of the substrate. It should be understood that the molten thermographic powder can be applied using conventional systems which can operate to raise the temperature of the thermographic powder above its melting point and allow the thermographic powder to maintain a temperature above its melting point until it is applied to the substrate. One such system that can be used is a conventional hot melt glue system that can be used to apply the molten thermographic powder to the substrate such as by way of a glue gun, sprayer (including powder and electrostatic spraying), or by use of a slot (ribbon) coater.

In a preferred embodiment of the invention, the texture of the surface treatment can be varied by controlling the temperature the melting/fusing application process. It has been found that by heating and applying the thermographic powder slightly above its melting point creates a textured surface. By heating and applying the thermographic powder at higher temperatures results in the material being more flowable (less viscous) allowing it to flow out to form less textured (more smooth) surface treatment. It should be understood that the degree of texturing depends on the amount (temperature) and duration of heat applied.

In another preferred embodiment of the invention, the particle size and the specific resins comprising the thermographic power can be varied to create a wide range textures of the surface treatment having various coefficients of friction. It has been found that by using smaller particle sizes generally creates a finer, more tightly spaced texture than surface treatments formed from larger particle sizes. It should also be understood that the texture of the surface treatment is also dependent on the specific resins and the temperature that the resins are heated to. It has also been found that by forming surface treatments using various particle sizes can form surfaces having different thicknesses. Forming surface treatments from thermographic powder having smaller particle sizes generally results in thinner surfaces than forming the surface treatment from thermographic powder of the same resin having larger particle sizes.

In another preferred embodiment of the invention, the desired surface treatment can be formed from a combination of surface treatments. For example, forming a first surface treatment from a thermographic powder having a first melting temperature and placing a second surface treatment formed from a thermographic powder having a second melting temperature (preferably lower than the first melting temperature) to partially cover the first surface treatment.

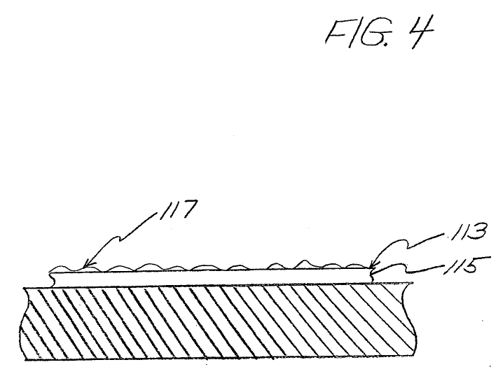

As shown in FIG. 4, in another preferred embodiment of the invention the upper surface 113 of the surface treatment 115 is provided with means 117 for increasing or decreasing the coefficient of friction of the surface treatment 115. For example means 117, such as sand, dirt, and the like, may be used to increase the coefficient of friction of the surface treatment 115. Such means for increasing the coefficient of friction is applied when the thermographic powder forming the surface treatment 115 is still in its soft semi-molten condition thereby allowing the means 117 to adhere to or bond with the upper surface 113. Other means 117 may be used to decreasing the coefficient of friction. Such means may include materials, such as polytetrafluoroethylene (TEFLON), silica, silicone, and other such means 117 effective for reducing the coefficient of friction of the resulting surface treatment 115 may be applied to the upper surface 113 or mixed with the thermographic resins used for the formation of the surface treatment 115 for particular applications.

In another preferred embodiment of the invention, the thermography powder, prior to being deposited onto the substrate, can be mixed with various other agents, biological agents or chemical compositions. For example, biological agents such as germicides, bactericides, pesticides, antiviral agents, and the like, as well aromatic chemical compositions fragrances or scents can be mixed with the thermography powder. In another preferred embodiment of the invention, the agents or chemical compositions can be deposited before or after the thermography powder is deposited onto the substrate. It should also now be understood that other materials such as illuminating agents, such as but not limited to chemiluminesent materials, or reflective materials, such as but not limited to aluminum flakes, may be added to the thermographic powder. Other materials such as silica, wax, and the like may also be mixed with the thermographic powder and deposited onto the substrate with the powder or deposited onto the substrate prior to the thermographic powder or after the thermographic powder is applied to the substrate. In one preferred embodiment of the invention the various agents, chemical compositions and other materials, such illuminating and reflective materials, are directly mixed with the thermography powder and deposited with the powder onto the substrate. In another preferred embodiment of the invention the various agents, chemical composition and other materials are applied to the substrate prior to depositing the thermography powder to the substrate. In still another preferred embodiment of the invention the various agents, chemical composition and other materials are applied to the substrate after the thermography powder is applied to the substrate. In another preferred embodiment of the invention the thermography powder and the various agents, chemical compositions, and other materials are applied in stages to produce a surface treatment having the desired characteristics.

It should now be apparent to those skilled in the art that the selected thermograph powder, and method of application can be selected to provide an effective encapsulating delivery means for delivering various encapsulated agents, chemical compositions and other materials. In this way, as the surface treatment during use wears away, the particular agent and chemical composition is exposed. For example, if the particular agent is a germicide, the active germicidal agent is gradually released to provide means for killing germs. In another example, if the particular agent is a fragrance, as the surface treatment wears, the fragrance is gradually released. It should now be apparent to those skilled in the art that the rate of wear and resulting release of the various agents and chemical compositions can be regulated by selection of the thermographic powder, the particular process of application selected, and the factor causing the abrasion and wearing away of the surface treatment.

In another preferred embodiment of the invention, after the thermographic powder is heated and fused, the resulting surface treatment can be textured using various processes, including, but not limited to, a calendar process, a grinding process, stippling, embossing, debossing, die cutting, etching, shearing, or a combination of the above.

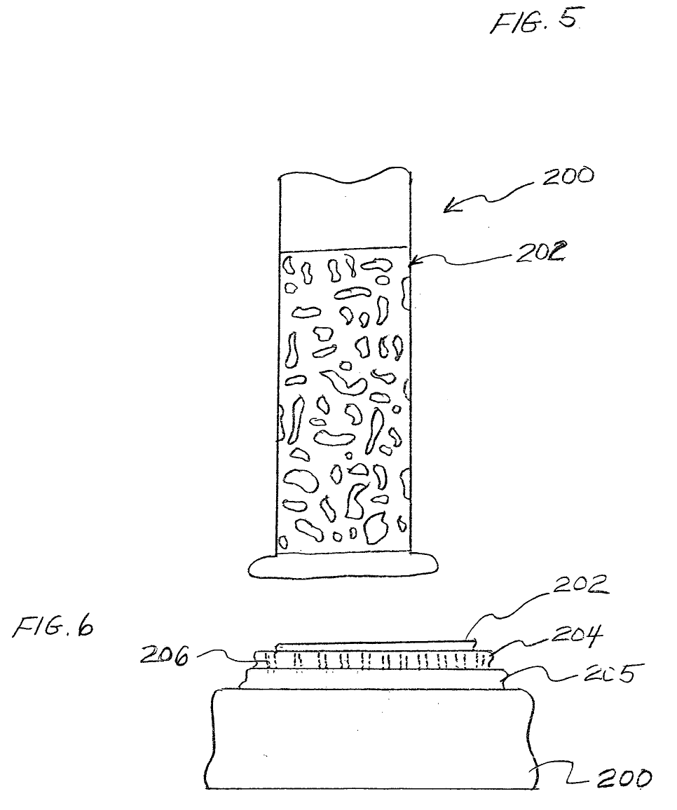

In another preferred embodiment of the invention is shown in FIGS. 5 and 6. A handle or grip 200, such as but not limited to a handle of a tennis racket or golf club, is shown having a surface treatment 202 applied thereto. In a preferred embodiment the substrate 204 having the surface treatment 202 applied thereto is placed around an inner cushion material 205, such as leather, cotton, or the like. As shown in FIG. 6, the substrate 204 is provided with apertures 206. During use, the apertures 206 allow the inner cushion material 205 to be used as a wick to effectively draw any moisture, such as sweat, forming along the surface treatment 202 to be absorbed into the inner cushion material 205. In another preferred embodiment of the invention, the wicking material is directly attached to the substrate.

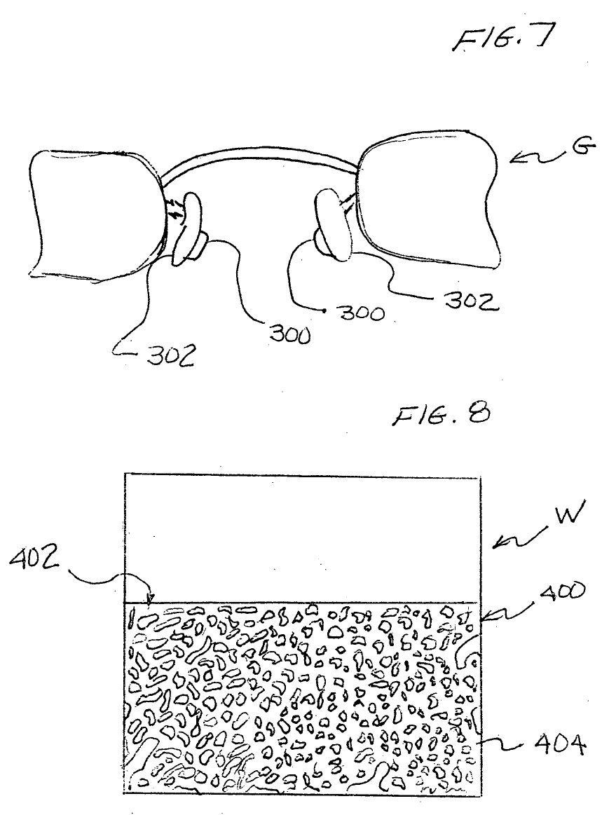

In another preferred embodiment of the invention, the surface treatment can be applied to various items such as eyeglasses, watch bands, straps, shoes and the like. As illustrated in FIG. 7, the surface treatment 300 of the subject invention is attached to the nose piece 302 of convention glasses G. In this way, during strenuous activity or perspiration by the wearer, the surface treatment operates as a no-slip surface treatment and maintains the glasses in its proper position. It should be understood that the surface treatment of the present invention can be used for a variety of similar applications such as placement along the inside surface of a watch band to maintain the watch in its proper position on the wrist, on straps, such as shirt straps for maintaining the strap its proper place on the shoulder, or on the soles of shoes for reducing the likelihood of the wearer slipping or for reducing the wear of the shoe or for repairing small holes that may form along the sole of the shoe.

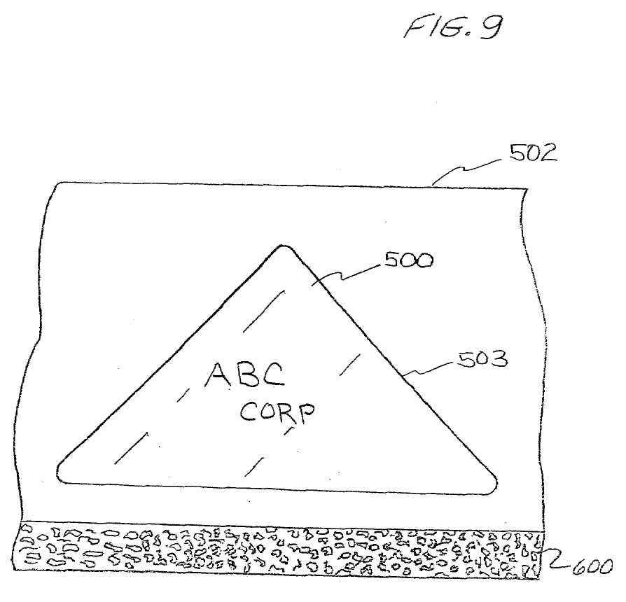

In another preferred embodiment of the invention, as shown in FIG. 8, the surface treatment 400 is applied to a window W. In this embodiment, the substrate 402 comprises a static cling material 404. The static cling material 404 can be opaque or transparent and can be in a variety of colors. It should be understood that the term “static cling material” as used herein refers to a variety of well-known materials that are conventionally known as a “static cling material” but requires no adhesives and further adhesion is not based on static electricity but rather relies on a pressure-sensitive film such as a plasticized vinyl film. Such material is available from Cincinnati Cordage and Paper Co. in Cincinnati, Ohio and identified as Matte Clear TC Vinyl with a MR 861 Special Removable with 80# White Craft release liner, such as sold by Flexcon Company of Spencer, Mass. and identified as CP Select top-coated clear cling vinyl with lay flat liner.

In another preferred embodiments of the invention a first surface treatment effective for operating as a no-slip surface as described hereinabove is applied to a first article and to a second surface treatment effective for operating as a no-slip surface as described hereinabove is applied to a second article. For example, the first surface treatment can be applied to a jar lid and the second surface treatment can be applied to a kitchen or stove mitten. During use, the two surface treatments will cooperate to enhance the gripping ability of the surfaces.

In another preferred embodiment of the invention, the surface treatment of the present invention can be used as a means for joining two surfaces together. For example, a surface having a surface treatment can be brought into contact with a second surface such that the surface treatment can be heated such that the surface melts. Upon cooling the surface treatment will attach to both articles thereby joining the articles together.

In another preferred embodiment of the invention, the surface treatment can be used to reduce or eliminate squeaks such as for example caused by vibration of overlapping surfaces by separating the surfaces using the surface treatment along areas creating the noise.

It has been found that using a substrate formed from a static cling material in combination with the surface treatment previously described when applied to a window, glass door, and the like forms an effective means for providing privacy while allowing a substantial amount of light to be transmitted there through and permits easy attachment, removal, and re-positioning of the surface.

In another preferred embodiment of the invention, as shown in FIG. 9, the surface treatment 500 of the subject application is applied to an article 502, such as, but not limited to building structures, bridge structures, motorized vehicle parts, railroad cars, fencing, signs, and other articles and structures. Preferably, the surface treatment is deposited along at least a portion of the surface 503 of the article using a hot spray device whereby melted thermographic resin is sprayed onto the surface 503. It should be understood, however, that the molten thermographic resin can also be applied using conventional systems which can operate to raise the temperature of the thermographic resin above its melting point and allow the thermographic resin to maintain a temperature above its melting point until it is applied to the surface 503. The applied thermographic resin(s) is then heated as described herein above such that the resulting surface treatment 500 formed is relatively smooth. It should now be apparent to those skilled in the art that the surface treatment 500 will operate to provide a protective barrier for the portion of the surface 503 covered by the surface treatment 500. For example, when applied over painted surfaces (such as shown covering a painted sign), the surface treatment 500 reduces the chances of paint chipping from minor impacts, such as with sand, dirt, and the like. Further, the surface treatment 500 forms a barrier that reduces oxidation of the covered surface 503 or damage caused by exposure to salt or high moisture environments. Further, the characteristics of the surface treatment 500 can be such that other foreign substances, such as paint applied by vandalism would not adhere to the surface treatment 500 or can be easily washed off or removed using solvents without affecting or damaging the underlying surface 503. It should also now be apparent that the surface treatment 500 will form a protective barrier that will not detract or significantly detract from the appearance of the article or structure. The thermographic resins forming the surface treatment 500 of the subject application can also be mixed with various well know materials that will reduce the transparency of UV rays through the surface treatment 500 thereby further protecting the underlying surface 503. It should also now be apparent that surface treatments 600 having thicker or multiple layers may also be applied to areas for increased protection against wear or minor impacts.

It should now be apparent to those skilled in the art that the surface treatment of the present invention can be used for a large variety of applications including, but not limited to, containers, flooring, table tops, bathroom fixtures, such as tubs, shower stalls, and the like, trays, coasters, tray supports, tools, measuring devices, musical instrument parts, motorized vehicle surfaces, building structures and components, bridges, railroad and mass transportation articles, and instruments. Further, such surface treatments having illuminating materials and/or reflective materials can be used for flooring or wall surfaces or on articles for operating in darken conditions or conditions with limited visibility.

It should now be apparent to those skilled in the art that the present invention provides a surface treatment for an article that can provide a desired coefficient of friction, that can be permanently or removably attached to the article, that can be clear or transparent, that can provide a protective barrier for the underlying surface, that is easily applied, does not detrimentally detract from the appearance of the article, and which is relatively cost effective for most applications.

We claim:

1. A method of applying a surface treatment to an article comprising the steps of:
applying a thermographic powder to a portion of the article, wherein the thermographic powder is applied in a molten state such that the thermographic powder adheres to the surface; and
cooling the molten thermographic powder to form the surface.

2. The method of claim 1 wherein the thermographic powder is applied to the substrate by dipping at least a portion of the substrate into a supply of molten thermographic powder.

3. The method of claim 1 wherein the thermographic powder is reheated to allow the thermographic powder to form a relatively smooth surface.

4. The method of claim 1 wherein the thermographic powder is formed from a mixture of thermographic powders, wherein the powders are formed from particles of substantially different sizes.

5. The method of claim 1 wherein the thermographic powder is formed from a polyamide resin.

6. The method of claim 1 wherein the thermographic powder is applied to the substrate using a holt-melt system.

7. The method of claim 1 wherein the thermographic powder is applied to the substrate using a sprayer.

8. The method of claim 1 further comprising the steps of:
selecting the composition and texture and thickness of the surface and heating the thermographic powder to the proper temperature and for the proper amount of time to form the desired surface.

9. The method of claim 1 further comprising the step of selecting the desired coefficient of friction for the surface.

10. The method of claim 1 wherein said thermographic powder is applied using a slot (ribbon) coater.

11. The method of claim 1 further comprising the step of adding a biological agent to the thermoplastic powder.

12. The method of claim 1 further comprising the step of adding an illumination agent to the thermoplastic powder.

13. The method of claim 1 further comprising the step of adding a reflective agent to the thermoplastic powder.

14. An article having a surface treatment applied thereon, said surface treatment is formed from a mixture formed from thermoplastic powder and means for increasing or decreasing the coefficient of friction of the surface treatment.

15. The article of claim 14 wherein said surface treatment further comprises an illumination means.

16. The article of claim 14 wherein said surface treatment further comprises a reflecting means.

17. The article of claim 14 wherein said surface treatment further comprises at least one biological agent.

18. The article of claim 14 wherein said surface treatment comprises means for reducing the transparency of UV rays passing through the surface treatment.

19. The article of claim 14, wherein said article is selected from the group consisting of flooring, counter tops, table tops, bathroom fixtures, windows, eyewear, clothing and wearing accessories, food and beverage containers, motorized vehicles, railroad cars, building structures, bridge structures, and articles for transporting objects.
